(19) United States
(12) Patent Application Publication
(10) Pub. No.: US 2026/0125292 A1
(43) Pub. Date: May 7, 2026

(54) WASTEWATER CONCENTRATION DEVICE AND CONCENTRATION METHOD

(71) Applicants: KURITA WATER INDUSTRIES LTD., Tokyo (JP); NATIONAL UNIVERSITY CORPORATION KOBE UNIVERSITY, HYOGO (JP)

(72) Inventors: Takahiro KAWAKATSU, Tokyo (JP); Kazuo KUMAGAI, Hyogo (JP); Hideto MATSUYAMA, Hyogo (JP)

(73) Assignees: KURITA WATER INDUSTRIES LTD., Tokyo (JP); NATIONAL UNIVERSITY CORPORATION KOBE UNIVERSITY, HYOGO (JP)

(21) Appl. No.: 19/114,454

(22) PCT Filed: Sep. 21, 2023
(86) PCT No.: PCT/JP2023/034271

§ 371 Date: Mar. 23, 2025

(30) Foreign Application Priority Data
Oct. 5, 2022 (JP) 2022-161068

(51) Int. Cl. C02F 1/42; B01D 15/36; B01D 61/02; B01D 61/04; B01D 61/08; B01D 71/16; C02F 1/44

(52) U.S. Cl. CPC C02F 1/42; B01D 15/362; B01D 15/363; B01D 61/025; B01D 61/04; B01D 61/08; B01D 71/16; C02F 1/441; B01D 2311/04; B01D 2313/50; C02F 2001/422; C02F 2001/425; C02F 2301/046

(57) ABSTRACT

A wastewater concentration device and a wastewater concentration method are provided, including an osmotically assisted reverse osmosis device that performs an osmotically assisted reverse osmosis method having a primary chamber and a secondary chamber separated by an osmotically assisted reverse osmosis membrane, and a water supply means for supplying water to be treated to the primary chamber. The water supply means treats at least a portion of the water to be treated with a cation exchange device or an anion exchange device to adjust a pH of water supplied to the osmotically assisted reverse osmosis device to a range between a first prescribed pH and a second prescribed pH (where the first prescribed pH is an alkaline pH and the second prescribed pH is an acidic pH).

### TECHNICAL FIELD

The present invention relates to a wastewater concentration device, and particularly to a wastewater concentration device using an osmotically assisted reverse osmosis method. Further, the present invention relates to a wastewater concentration method using this concentration device.

### RELATED ART

There have been many attempts to concentrate waste liquid to recover valuable materials or reduce industrial waste costs. In the electronics industry, large amounts of isopropyl alcohol (IPA) are used, and there is a movement to recover and reuse it from the perspective of resource conservation and decarbonization.

Conventionally, the evaporation method using an evaporator has been generally employed as a method for concentrating wastewater. In this method, the challenge is the high energy consumption due to the phase change of water. By using an RO membrane, energy consumption reduction is expected as it does not involve water phase change. However, as the osmotic pressure of the wastewater increases, high pressure must be applied, requiring high-pressure specification equipment. To concentrate an IPA aqueous solution with a concentration of 1 to 5 wt % to an IPA concentration of 15 wt % or higher, a pressure of 10 MPa or more is necessary, which is not practical.

When concentrating a high osmotic pressure aqueous solution using a reverse osmosis (RO) membrane, there is an osmotically assisted reverse osmosis method (OARO method) in which an aqueous solution with a lower osmotic pressure than the feed water side is passed through the permeate water side to reduce the osmotic pressure difference and lower the driving pressure (Patent Literature 1, etc.).

In the OARO method, since liquid is also passed through the permeate side, hollow fiber RO membranes are structurally suitable. As a commercially available hollow fiber RO membrane, the BC (brine concentration) membrane from Toyobo Co., Ltd. is known. Since the material of the BC membrane is cellulose acetate, it is necessary to maintain the pH between 3 and 8.

When using a BC membrane for concentrating wastewater, if the pH of the wastewater is lower than 3 or higher than 8, pH adjustment is necessary. This requires the addition of alkali or acid for neutralization, which leads to problems such as increased osmotic pressure, increased concentration of salts, and increased cost of chemicals.

### CITATION LIST

### Patent Literature

Patent Literature 1: Japanese Patent Publication No. 2019-504763.

### SUMMARY OF INVENTION

### Technical Problem

When concentrating wastewater using the osmotically assisted reverse osmosis method, there are cases where the pH of the wastewater is higher than 8 or lower than 3. To adjust the pH, the addition of acid or alkali is generally considered, but the salt generated by neutralization further increases the osmotic pressure. Further, in the case where the purpose was to concentrate organic components, the generated salt would also be concentrated simultaneously.

The present invention aims to provide a wastewater concentration device and concentration method that may stably perform wastewater concentration treatment by adjusting the pH of the water supplied to the osmotically assisted reverse osmosis device.

### Solution to Problem

A wastewater concentration device according to one aspect of the present invention is a wastewater concentration device that includes an osmotically assisted reverse osmosis device that performs an osmotically assisted reverse osmosis method having a primary chamber and a secondary chamber separated by an osmotically assisted reverse osmosis membrane, and a water supply means that supplies water to be treated to the primary chamber, in which the water supply means includes an ion exchange device.

In the wastewater concentration device according to one aspect of the present invention, a pH of the water to be treated is alkaline, and the ion exchange device is a cation exchange device.

In the wastewater concentration device according to one aspect of the present invention, a pH of the water to be treated is acidic, and the ion exchange device is an anion exchange device.

In the wastewater concentration device according to one aspect of the present invention, the water supply means is configured to be capable of mixing treated water from the ion exchange device with water to be treated that has not undergone ion exchange treatment to adjust a pH of water supplied to the osmotically assisted reverse osmosis device to a range between a first prescribed pH and a second prescribed pH (where a first prescribed pH is an alkaline pH and a second prescribed pH is an acidic pH).

In the wastewater concentration device according to one aspect of the present invention, the water supply means is configured to be switchable between:
a flow path selection that mixes treated water from the ion exchange device with water to be treated that has not undergone ion exchange treatment to adjust a pH of water supplied to the osmotically assisted reverse osmosis device to a range between a first prescribed pH and a second prescribed pH (where a first prescribed pH is an alkaline pH and a second prescribed pH is an acidic pH); and
a flow path selection that supplies treated water with a pH between a first prescribed pH and a second prescribed pH from the ion exchange device to the osmotically assisted reverse osmosis device.

In the wastewater concentration device according to one aspect of the present invention, the water supply means is configured to be switchable between:
a flow path selection that mixes treated water from the ion exchange device with water to be treated that has not undergone ion exchange treatment to adjust a pH of water supplied to the osmotically assisted reverse osmosis device to a range between a first prescribed pH and a second prescribed pH (where a first prescribed pH is an alkaline pH and a second prescribed pH is an acidic pH);
a flow path selection that supplies treated water with a pH between a first prescribed pH and a second prescribed pH from the ion exchange device to the osmotically assisted reverse osmosis device; and
a flow path selection that supplies the water to be treated as is to the osmotically assisted reverse osmosis device when a pH of the water to be treated is between a first prescribed pH and a second prescribed pH.

In the wastewater concentration device according to one aspect of the present invention, a material of the osmotically assisted reverse osmosis membrane is cellulose acetate.

A wastewater concentration method according to one aspect of the present invention is a wastewater concentration method using a wastewater concentration device including an osmotically assisted reverse osmosis device having a primary chamber and a secondary chamber separated by an osmotically assisted reverse osmosis membrane, and a water supply means having an ion exchange device that supplies water to be treated to the primary chamber. In the wastewater concentration method, a pH of water supplied to the osmotically assisted reverse osmosis device is adjusted by passing water through the ion exchange device.

In the wastewater concentration method according to one aspect of the present invention, a pH of water supplied to the osmotically assisted reverse osmosis device is adjusted to a range between a first prescribed pH and a second prescribed pH (where a first prescribed pH is an alkaline pH and a second prescribed pH is an acidic pH).

In the wastewater concentration method according to one aspect of the present invention, when a pH of the water to be treated is higher than a first prescribed pH, at least a portion of the water to be treated is treated by a cation exchange device, and when a pH of the water to be treated is lower than a second prescribed pH, at least a portion of the water to be treated is treated by an anion exchange device.

### Effects of Invention

In one aspect of the present invention, when concentrating high pH wastewater using the osmotically assisted reverse osmosis method, the wastewater is pretreated with cation exchange resin to remove cation components contributing to the high pH, while simultaneously lowering the pH of the wastewater by hydrogen ions released through ion exchange. Further, in the case of concentrating low pH wastewater using the osmotically assisted reverse osmosis method, the wastewater is pretreated with anion exchange resin to remove anion components contributing to the low pH, while simultaneously raising the pH of the wastewater by hydroxide ions released through ion exchange.

It is noted that, in one aspect of the present invention, in the case where high pH wastewater with a pH higher than 8 is treated with cation exchange resin and the pH becomes lower than 3, it is possible to adjust the pH to a range of 3 to 8 by mixing it with the original high pH wastewater. Similarly, in the case where low pH wastewater with a pH lower than 3 is treated with anion exchange resin and the pH becomes higher than 8, it is possible to adjust the pH to a range of 3 to 8 by mixing it with the original low pH wastewater. It is noted that pH 3 and 8 are examples and are not limited to these values.

In this manner, for both high pH wastewater and low pH wastewater, treatment with ion exchange resin may simultaneously reduce salt concentration and adjust pH. It is noted that, in the present invention, even in cases where the material of the osmotically assisted reverse osmosis membrane is not cellulose acetate and the pH range is not 3 to 8, it is possible to perform assisted reverse osmosis membrane treatment after ion exchange resin treatment for the purpose of reducing acids, alkalis, and salts in the wastewater.

### BRIEF DESCRIPTION OF DRAWINGS

FIG. 1 is a configuration diagram of an osmotically assisted reverse osmosis device according to an embodiment.

FIG. 2 is a configuration diagram of an osmotically assisted reverse osmosis device according to an example.

FIG. 3 is a graph showing experimental results.

### DESCRIPTION OF EMBODIMENTS

An embodiment is described below with reference to the drawings.

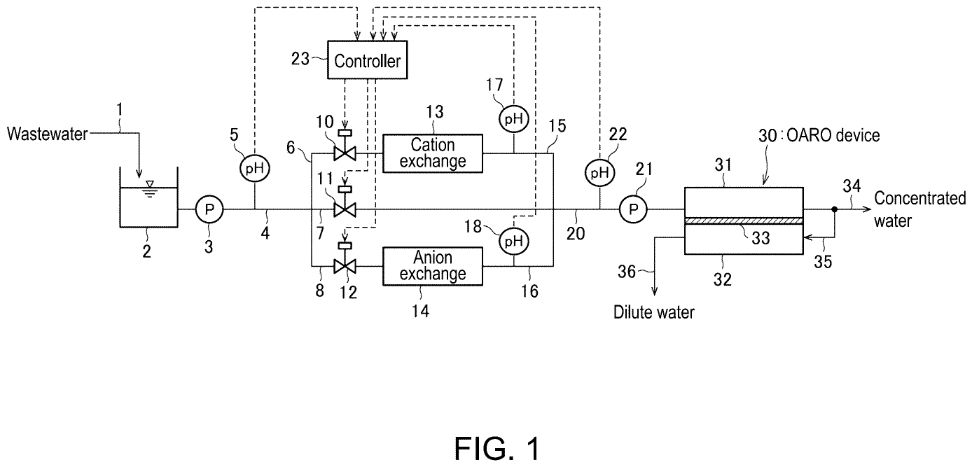

FIG. 1 is a configuration diagram of an osmotically assisted reverse osmosis device according to an embodiment of the present invention. Wastewater (raw wastewater) to be treated is introduced into a raw water tank 2 through a raw water pipe 1. The raw wastewater in the raw water tank 2 is sent to a pipe 4 by a pump 3. A pH meter 5 is provided on the pipe 4. The pipe 4 branches into branch pipes 6, 7, and 8.

The branch pipe 6 is connected to the inlet side of a cation exchange resin tower 13 through a valve 10. The outlet side of the cation exchange resin tower 13 is connected to a merging pipe 20 through a pipe 15.

The branch pipe 7 is connected to the merging pipe 20 through a valve 11.

The branch pipe 8 is connected to the inlet side of an anion exchange resin tower 14 through a valve 12. The outlet side of the anion exchange resin tower 14 is connected to the merging pipe 20 through a pipe 16.

pH meters 17, 18, and 22 are provided on the pipes 15 and 16 and the merging pipe 20, respectively.

A pump 21 is provided on the merging pipe 20, and the discharge side of the pump 21 is connected to an inlet of a primary chamber 31 of an osmotically assisted reverse osmosis device (OARO device) 30. The interior of the OARO device 30 is separated into a primary chamber 31 and a secondary chamber 32 by an osmotically assisted reverse osmosis membrane 33 consisting of a cellulose acetate membrane.

A concentrated water pipe 34 is connected to the outlet of the primary chamber 31. In this embodiment, the pipe 35 branching from the concentrated water pipe 34 is connected to the inlet of the secondary chamber 32. A pipe 36 for extracting dilute water is connected to the outlet of the secondary chamber 32.

Output signals from the pH meters 5, 17, 18, and 22 are input to a controller 23, and the valves 10, 11, and 12 are controlled by signals from the controller 23.

The concentration of wastewater by this osmotically assisted reverse osmosis device is carried out according to any of the following flows (1) to (5).
(1) Wastewater with pH higher than 8→Cation exchange resin treatment→Wastewater with pH 3 to 8→Osmotically assisted reverse osmosis membrane treatment
(2) Wastewater with pH higher than 8→Cation exchange resin treatment→Wastewater with pH lower than 3→Mixing with original wastewater→Wastewater with pH 3 to 8→Osmotically assisted reverse osmosis membrane treatment
(3) Wastewater with pH lower than 3→Anion exchange resin treatment→Wastewater with pH 3 to 8→Osmotically assisted reverse osmosis membrane treatment
(4) Wastewater with pH lower than 3→Anion exchange resin treatment→Wastewater with pH higher than 8→Mixing with original wastewater→Wastewater with pH 3 to 8→Osmotically assisted reverse osmosis membrane treatment
(5) Wastewater with pH 3 to 8→Direct osmotically assisted reverse osmosis membrane treatment

### Flow (1)

In the case of flow (1), the valve 10 is opened, the valves 11 and 12 are closed, and the wastewater is passed through the cation exchange resin tower 13. In this case, since the pH of the effluent from the cation exchange resin tower 13 detected by the pH meters 17 and 22 is between 3 and 8, it is directly passed through to the primary chamber 31 of the osmotically assisted reverse osmosis device 30, and the concentrated water flows out from the pipe 34. A portion of the concentrated water is passed through the pipe 35 to the secondary chamber 32. The primary chamber 31 is in a state where the water pressure is higher than that in the secondary chamber 32 because the discharge pressure of the pump 21 is applied. As a result, H₂O components from the wastewater in the primary chamber 31 permeate through the osmotically assisted reverse osmosis membrane 32 to the secondary chamber 32, and the effluent from the primary chamber 31 becomes concentrated water, while the effluent from the secondary chamber 32 becomes dilute water.

### Flow (2)

In flow (2), the valves 10 and 11 are opened, and the valve 12 is closed. The pH of the effluent from the cation exchange resin tower 13 detected by the pH meter 17 is below 3, but by merging with the original wastewater with pH above 8 from the pipe 7 in the merging pipe 20, the pH in the merging pipe 20 becomes 3 to 8. It is noted that the opening degrees of the valves 10 and 11 are controlled so that the pH detected by the pH meter 22 is between 3 and 8.

### Flow (3)

In the case of flow (3), the valve 12 is opened, the valves 10 and 11 are closed, and the wastewater is passed through the anion exchange resin tower 14. In this case, since the pH of the effluent from the anion exchange resin tower 14 detected by the pH meters 18 and 22 is between 3 and 8, it is directly passed through to the primary chamber 31 of the osmotically assisted reverse osmosis device 30, and the concentrated water flows out from the pipe 34. A portion of the concentrated water is passed through the pipe 35 to the secondary chamber 32. The primary chamber 31 is in a state where the water pressure is higher than that in the secondary chamber 32 because the discharge pressure of the pump 21 is applied. As a result, H₂O components from the wastewater in the primary chamber 31 permeate through the osmotically assisted reverse osmosis membrane 32 to the secondary chamber 32, and the effluent from the primary chamber 31 becomes concentrated water, while the effluent from the secondary chamber 32 becomes dilute water.

### Flow (4)

In flow (4), the valves 11 and 12 are opened, and the valve 10 is closed. The pH of the effluent from the anion exchange resin tower 14 detected by the pH meter 18 is above 8, but by merging with the original wastewater with pH below 3 from the pipe 7 in the merging pipe 20, the pH in the merging pipe 20 becomes 3 to 8. It is noted that the opening degrees of the valves 11 and 12 are controlled so that the pH detected by the pH meter 22 is between 3 and 8.

### Flow (5)

In the case of flow (5), the valves 10 and 12 are closed and the valve 11 is opened, the wastewater with pH 3 to 8 in the raw water tank 2 is passed through the pipe 7, the merging pipe 20, and the pump 21 to the primary chamber 31 of the osmotically assisted reverse osmosis device 30, concentrated water flows out from the pipe 34, and dilute water flows out from the pipe 36.

In this manner, in any of the flows (1) to (5), since the pH of the wastewater passed through the osmotically assisted reverse osmosis device 30 is between 3 and 8, even if the osmotically assisted reverse osmosis membrane 33 is a cellulose acetate membrane, the concentration treatment may be performed stably over a long period without deterioration.

It is noted that the osmotically assisted reverse osmosis membrane is not limited to a cellulose acetate membrane.

In the above-described embodiment, the discharge pressure of the pump 21 for sending the water to be treated to the osmotically assisted reverse osmosis device 30 is preferably about 1 to 10 MPa, particularly about 3 to 8 MPa.

In the above-described embodiment, the first prescribed pH=8 and the second prescribed pH=3, but the present invention is not limited thereto. In the present invention, the first prescribed pH may be 6 to 8, particularly 7 to 8, and the second prescribed pH may be 3 to 6, particularly about 3 to 5.

### EXAMPLES

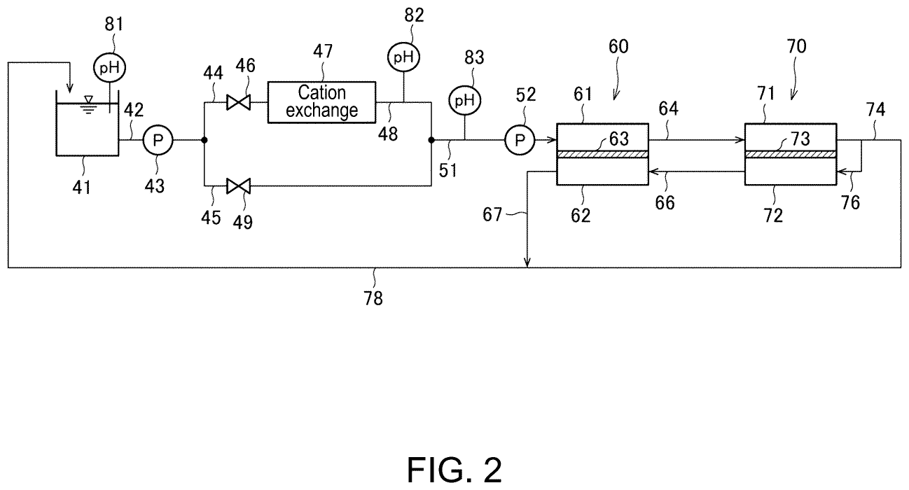

As shown in FIG. 2, wastewater with a pH of 11.2 was concentrated using a test osmotically assisted reverse osmosis system provided with a cation exchange resin tower 47, in which osmotically assisted reverse osmosis devices 60 and 70 were installed in series in two stages, and the concentrated water from the osmotically assisted reverse osmosis device 60 was further concentrated by the osmotically assisted reverse osmosis device 70. The main conditions were as follows:
Wastewater: IPA wastewater from the electronics industry (pH 11.2, IPA concentration 1.1 wt %, Na ion 31 mg/L)
Cation exchange resin tower: Filled with 125 mL of cation exchange resin (KR-UC1, manufactured by Kurita Water Industries Ltd.)
Osmotically assisted reverse osmosis device: HOLLOSEP Mini (registered trademark) BC membrane module (hollow fiber membrane module, membrane area 1.1 m², manufactured by Toyobo Co., Ltd.)
Amount of wastewater in the raw water tank 41 (before starting water flow): 10 L
Water supply volume of pump 43: 120 mL/min
Discharge pressure of pressure boosting pump 52: 5.5 MPa
Water introduction volume to secondary chambers 62 and 72: 20 mL/min

### Example 1

Valves 46 and 49 were opened, and wastewater was supplied from a pipe 42 and the pump 43 to both pipes 44 and 45. The ratio of [water supply volume to pipe 44]/[water supply volume to pipe 45] was set to 20/7.

The pH of the effluent from the cation exchange resin tower 47 to the pipe 48 (detected value by the pH meter 82) was 3.3, the Na concentration was 0.2 mg/L, and the IPA concentration was 1.1 wt % (the same as the raw water IPA concentration).

The pH of the merged water in the pipe 51 (detected value by the pH meter 83) was 4.0. This merged water was supplied to the primary chamber 61 of the osmotically assisted reverse osmosis device 60 by the pump 52, and the concentrated water from the primary chamber 61 was supplied to the primary chamber 71 of the osmotically assisted reverse osmosis device 70 through the pipe 64.

A portion (20 mL/min) of the concentrated water flowing out from the primary chamber 71 to the pipe 74 was passed through the secondary chamber 72 via the branch pipe 76, and its effluent was passed through the secondary chamber 62 of the osmotically assisted reverse osmosis device 60 via the pipe 66. The dilute water flowing out from the secondary chamber 62 to the pipe 67 and the remaining portion of the concentrated water from the pipe 74 were returned to the raw water tank 41 through the pipe 78.

### <Results>

The operation was conducted for 9 days, and the IPA concentration in the concentrated water from the pipe 74 was 4.6 wt % on the 4th and 8th days. In addition, when ion chromatography analysis (instrument: ICS900, column: IonPac ICE-AS1 (manufactured by Thermo Fisher Scientific)) was performed on the acetic acid concentration in the raw water tank 41, it was consistently below the detection limit of 0.5 mg/L.

### Comparative Example 1

A test was conducted under the same conditions as in Example 1, except that the valve 46 was closed, the valve 49 was opened, and the entire amount of raw water was passed directly through osmotically assisted reverse osmosis devices 60 and 70.

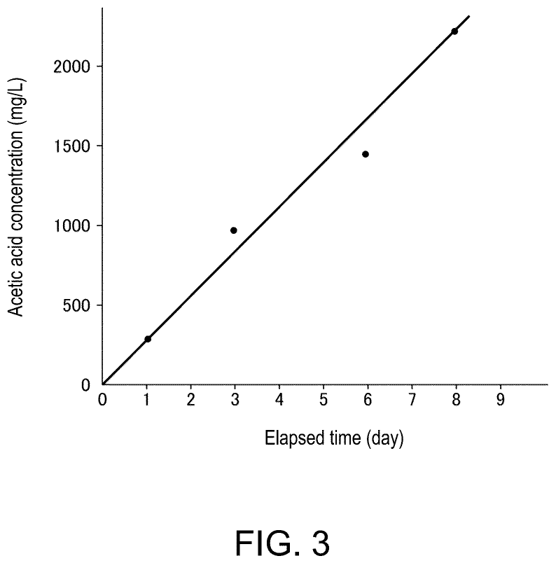

The measurement results of the acetic acid concentration in the raw water tank 41 are shown in FIG. 3.

As shown in FIG. 3, the acetic acid concentration increased over time. This is considered to be due to the hydrolysis of cellulose acetate, which is the material of the BC membrane, resulting in the elution of acetic acid when operating at pH 11.2. It is noted that the concentrated water IPA concentration in Comparative Example 1 was 3.6 wt % on the 4th day and 3.2 wt % on the 8th day.

Based on the above results, it was recognized that stable concentration treatment may be performed by conducting ion exchange resin treatment before concentrating the wastewater with the BC membrane, and adjusting the pH to 3 to 8.

The present invention has been described in detail using specific embodiments, but it is clear to those skilled in the art that various changes are possible within the range where the effects of the invention are achieved.

This present application is based on Japanese Patent Application No. 2022-161068 filed on Oct. 5, 2022, the entire contents of which are incorporated herein by reference.

### REFERENCE SIGNS LIST

2, 41 Raw water tank
13, 47 Cation exchange resin tower
14 Anion exchange resin tower
30, 60, 70 Osmotically assisted reverse osmosis device
33, 63, 73 Osmotically assisted reverse osmosis membrane

1. A wastewater concentration device comprising an osmotically assisted reverse osmosis device that performs an osmotically assisted reverse osmosis method having a primary chamber and a secondary chamber separated by an osmotically assisted reverse osmosis membrane, and a water supply means that supplies water to be treated to the primary chamber, wherein
the water supply means comprises an ion exchange device.

2. The wastewater concentration device according to claim 1, wherein a pH of the water to be treated is alkaline, and the ion exchange device is a cation exchange device.

3. The wastewater concentration device according to claim 1, wherein a pH of the water to be treated is acidic, and the ion exchange device is an anion exchange device.

4. The wastewater concentration device according to claim 1, wherein the water supply means is configured to be capable of mixing treated water from the ion exchange device with water to be treated that has not undergone ion exchange treatment to adjust a pH of water supplied to the osmotically assisted reverse osmosis device to a range between a first prescribed pH and a second prescribed pH, where a first prescribed pH is an alkaline pH and a second prescribed pH is an acidic pH.

5. The wastewater concentration device according to claim 1, wherein the water supply means is configured to be switchable between:
a flow path selection that mixes treated water from the ion exchange device with water to be treated that has not undergone ion exchange treatment to adjust a pH of water supplied to the osmotically assisted reverse osmosis device to a range between a first prescribed pH and a second prescribed pH, where a first prescribed pH is an alkaline pH and a second prescribed pH is an acidic pH; and
a flow path selection that supplies treated water with a pH between a first prescribed pH and a second prescribed pH from the ion exchange device to the osmotically assisted reverse osmosis device.

6. The wastewater concentration device according to claim 1, wherein the water supply means is configured to be switchable between:
a flow path selection that mixes treated water from the ion exchange device with water to be treated that has not undergone ion exchange treatment to adjust a pH of water supplied to the osmotically assisted reverse osmosis device to a range between a first prescribed pH and a second prescribed pH, where a first prescribed pH is an alkaline pH and a second prescribed pH is an acidic pH;
a flow path selection that supplies treated water with a pH between a first prescribed pH and a second prescribed pH from the ion exchange device to the osmotically assisted reverse osmosis device; and
a flow path selection that supplies the water to be treated as is to the osmotically assisted reverse osmosis device when a pH of the water to be treated is between a first prescribed pH and a second prescribed pH.

7. The wastewater concentration device according to claim 1, wherein a material of the osmotically assisted reverse osmosis membrane is cellulose acetate.

8. A wastewater concentration method using a wastewater concentration device comprising an osmotically assisted reverse osmosis device having a primary chamber and a secondary chamber separated by an osmotically assisted reverse osmosis membrane, and a water supply means having an ion exchange device that supplies water to be treated to the primary chamber, wherein the wastewater concentration method comprises:
adjusting a pH of water supplied to the osmotically assisted reverse osmosis device by passing water through the ion exchange device.

9. The wastewater concentration method according to claim 8, wherein a pH of water supplied to the osmotically assisted reverse osmosis device is adjusted to a range between a first prescribed pH and a second prescribed pH, where a first prescribed pH is an alkaline pH and a second prescribed pH is an acidic pH.

10. The wastewater concentration method according to claim 9, wherein when a pH of the water to be treated is higher than a first prescribed pH, at least a portion of the water to be treated is treated by a cation exchange device, and
when a pH of water to be treated is lower than a second prescribed pH, at least a portion of water to be treated is treated by an anion exchange device.
